(19) United States
(12) Patent Application Publication
(10) Pub. No.: US 2025/0303526 A1
(43) Pub. Date: Oct. 2, 2025

(54) CLAMP

(71) Applicant: Mueller International, LLC, Atlanta, GA (US)

(72) Inventors: David Latimore Hughes, JR., Signal Mountain, TN (US); Walter Pierce Wojick, Lookout Mountain, GA (US); Daryl Lee Gibson, Chattanooga, TN (US); Alice Meredith Byrnes, Chattanooga, TN (US); Timothy Wayne Stern, Hixon, TN (US)

(21) Appl. No.: 18/622,446

(22) Filed: Mar. 29, 2024

(51) Int. Cl. B25B 5/14; B25B 5/08

(52) U.S. Cl. CPC B25B 5/147; B25B 5/08

(57) ABSTRACT

A clamp includes a housing, the housing defining a first end and a second end; at least one tongue connected to the housing and extending proximate the first end; a gasket arranged within and in contact with the housing; and at least one clamping assembly coupled to the housing, wherein each clamping assembly engages at least one tongue.

### TECHNICAL FIELD

This disclosure relates to plumbing. More specifically, this disclosure relates to pipe repair.

### BACKGROUND

Plumbing and pipe repair can be costly. Replacing entire sections of piping can be cost-prohibitive in certain circumstances. In various aspects, clamps can be used to provide repair without replacement of piping elements. However, clamps can be of a varying arrangement. Some clamps can be wide range clamps, applicable to multiple pipe section diameters and dimensions. Wide range clamps can be costly and include costly components. Dedicated-size clamps can also be utilized, but using a dedicated-size clamp can require that the technician repairing the piping element have the specific sized clamp needed for that application.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect of the current disclosure, a clamp for encapsulating a piping element can include a housing, the housing defining a first end and a second end; at least one tongue can be connected to the housing and extending proximate the first end; a gasket can be arranged within and in contact with the housing, the gasket can be arranged to encapsulate the piping element; and at least one clamping assembly can be coupled to the second end, wherein each clamping assembly can engage at least one tongue.

In another aspect of the current disclosure, a clamp can include a housing, the housing defining a first end and a second end; a first tongue can be connected to the housing and extending proximate the first end; a second tongue can be connected to the housing and extending proximate the first end; a first clamping assembly and a second clamping assembly, each clamping assembly can include a wedge housing that can define a top, a bottom, a front wall, a back wall, a first side wall, and a second side wall; the front wall can be of a smaller dimension than the back wall such that the top is angled with respect to the bottom, wherein the front wall can define a front wall tongue pathway, wherein the back wall can define a back wall tongue pathway, and wherein the wedge housing can define a wedge void in communication with the front wall tongue pathway and with the back wall tongue pathway; a wedge can be arranged within the wedge void, the wedge can define a top, a bottom, a front, a back, a first side, and a second side, wherein the top of the wedge can be angled with respect to the bottom, wherein the top of the wedge can be in contact with a top of the wedge void; the first clamping assembly can be couple to the second end, wherein the first tongue can be arranged within the front wall tongue pathway and the back wall tongue pathway of the first clamping assembly, wherein the wedge of the first clamping assembly can be in contact with a surface of the first tongue; and the second clamping assembly can be coupled to the second end, wherein the second tongue can be arranged within the front wall tongue pathway and the back wall tongue pathway of the second clamping assembly, wherein the wedge of the first clamping assembly can be in contact with a surface of the second tongue.

In another aspect of the current disclosure, a method of installing a clamp onto a piping element can be achieved by obtaining a clamp, the clamp can include a housing, the housing can define a first end and a second end; at least one tongue can be connected to the housing and extending proximate the first end; a gasket can be arranged within and in contact with the housing, the gasket can be arranged to encapsulate the piping element; and at least one clamping assembly can be coupled to the second end; arranging the gasket around the piping element; arranging the clamp around the gasket and piping element; inserting at least one tongue into at least one clamping assembly; arranging a clamping tool in contact with the clamping assembly and with a portion of one tongue; and actuating the clamping tool to achieve tightening of the clamp by moving at least one tongue in a tightening direction with respect to at least one clamping assembly.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1 is a perspective view of a clamp in accord with one aspect of the current disclosure.

FIG. 2 is another perspective view of the clamp of FIG. 1.

FIG. 3 is another perspective view of the clamp of FIG. 1.

FIG. 4 is a perspective view of a wedge housing of the clamp of FIG. 1 in accord with one aspect of the current disclosure.

FIG. 5 is another perspective view of the wedge housing of FIG. 4.

FIG. 6 is a perspective view of a wedge of the clamp of FIG. 1 in accord with one aspect of the current disclosure.

FIG. 7 is another perspective view of the wedge of FIG. 6.

FIG. 8 is a perspective view of another aspect of a wedge of the clamp of FIG. 1.

FIG. 9 is a perspective view of a spring of the clamp of FIG. 1 in accord with one aspect of the current disclosure.

FIG. 10 is a side view of the clamp of FIG. 1.

FIG. 11 is another perspective view of the clamp of FIG. 1.

FIG. 12 is a perspective view of a housing in accord with one aspect of the current disclosure.

FIG. 13 is a perspective view of the clamp of FIG. 1 in actuation with a tool in accord with one aspect of the current disclosure.

FIG. 14 is a side view of another clamp in accord with one aspect of the current disclosure.

FIG. 15 is a perspective view of another clamp in accord with one aspect of the current disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a break check valve nearest to an outlet of the valve, and “rear” is the end of the break check valve which can be opposite or distal the front. “Horizontal” or “horizontal orientation” describes that which is in a plane extending from left to right and aligned with the horizon. “Vertical” or “vertical orientation” describes that which is in a plane which can be angled at 90 degrees to the horizontal.

Disclosed is a piping clamp along with associated methods, systems, devices, and various apparatus. The clamp includes features and designs allowing wide range applicability with minimal cost. It would be understood by one of skill in the art that the disclosed clamp is described in but a few exemplary embodiments among many. No particular terminology or description should be considered limiting on the disclosure or the scope of any claims issuing therefrom.

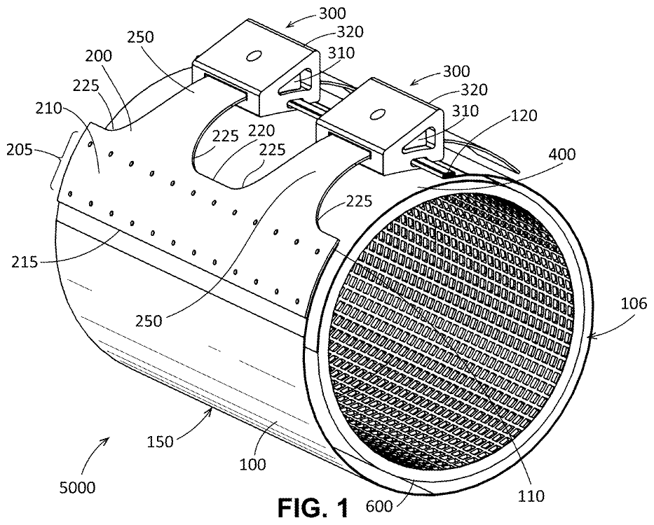

One embodiment of a clamp 5000 can be seen as disclosed and described with reference to FIGS. 1-3. In various aspects, the clamp 5000 can be of a wide range of applicability to varying pipe diameters while also minimizing cost and reducing or eliminating the use of costly components.

The clamp 5000 can comprise a variety of elements that are described herein with reference to the figures. One of skill in the art would understand that no particular aspect or element of the disclosed clamp 5000 should be considered limiting on the scope of the disclosure, as an assortment of elements of the clamp 5000 can be varied from one aspect to another. As such, the clamp 5000 can be considered just one among many possible aspects of the disclosure.

The clamp 5000 can comprise a housing 100. In the current aspect, the housing 100 can be a metallic sheet formed into a portion of a hollow cylinder. In various aspects, the housing 100 can be of varying constructions including fiberglass, polymeric materials, varying metals, and composites. The housing 100 can be generally cylindrical in shape and can be less than a full circumference of a cylinder, thereby allowing an opening between a first end 110 of the housing 100 and a second end 120 of the housing 100. The housing 100 can define a cavity 106 as a part of its cylindrical shape to accommodate a piping element such as a pipe or other even a piping joint. In field operation, the clamp 5000 can be arranged around a piping element for the purpose of sealing a damaged piping element, such as in the scenario of fixing a leak.

The housing 100 can be connected to a tongue attachment 200 proximate the first end 110. In the current aspect, the housing 100 can be connected to the tongue attachment 200 by rivets 205. In the current aspect, the housing 100 can be connected to the tongue attachment 200 by 24 rivets 205. The housing 100 together with the tongue attachment 200 can form a housing assembly 150. In various aspects, varying numbers of rivets 205 can be utilized. In various aspects, the tongue attachment 200 can be welded to the housing 100. In various aspects, the tongue attachment 200 can be integrated into the construction of the housing 100 such that the housing 100 can comprise the tongue attachment 200 as an integral or monolithic element.

The tongue attachment 200 can comprise an attachment portion 210 into which the rivets 205 can be driven. The attachment portion 210 can define an attachment end 215 of the attachment portion 210 and of the tongue attachment 200. The tongue attachment 200 can also comprise at least one tongue 250. In the current aspect, each tongue 250 can extend from a tongue end 220 of the attachment portion 210. At least one fillet 225 can be defined at the junction of tongue 250 with the attachment portion 210.

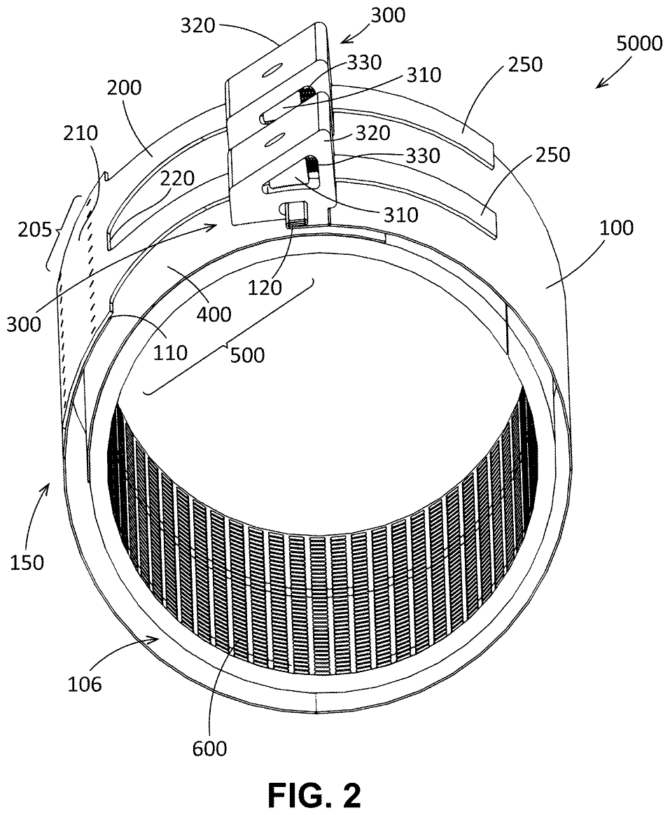

Each tongue 250 can extend into a clamping assembly 300. The clamping assembly 300 can comprise a wedge housing 320 secured to the housing 100. The clamping assembly 300 can also comprise a wedge 310 located within the wedge housing 320. The wedge 310 can be connected to the wedge housing 320 by a spring 330 (shown in FIG. 2).

A clamp shield 400 can be arranged within the housing 100 in the region of the housing assembly 150 that includes each tongue 250 and each clamping assembly 300, as well as the attachment portion 210 and rivets 205. The clamp 5000 can also comprise a gasket 600 arranged inside the housing assembly 150. The gasket 600 can be formed of a water-sealing material such as rubbers, elastomers, polymers, waxes, greases, various metals, or combinations thereof. The clamp shield 400 can be arranged in such a way as to protect the gasket 600 from features of the clamp 5000 that form a clamping region 500, arranged specifically from the second end 120 to the first end 110. As such, the clamp shield 400 can be slightly larger than the clamping region 500 to be able to protect the gasket 600 from the various elements providing clamping force to the clamp 5000.

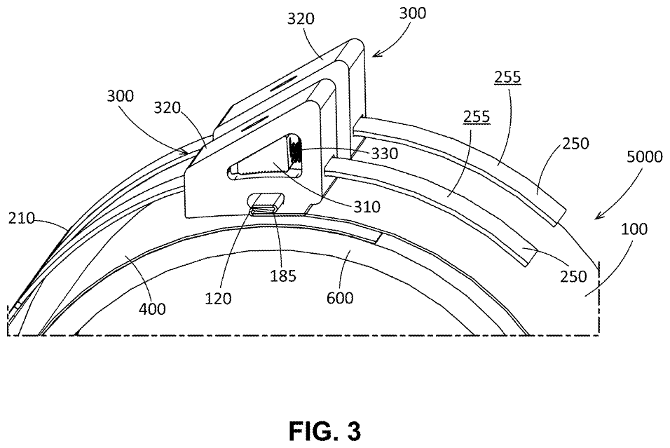

With specific reference to FIG. 3, an end stop 185 can be formed proximate the second end 120 of the housing 100. The end stop 185 can be a crimp in various aspects. The end stop 185 can provide a mechanism to attach the wedge housing 320 to the housing 100. Additionally, each tongue 250 can comprise an outer surface 255. In varying aspects, the outer surface 255 can comprise friction inducing elements such as etching, roughening, or texturing. In various aspects, the outer surface 255 can comprise teeth or other physical elements to encourage engagement when in operation. In various aspects, the outer surface 255 can be simple finished metal. In various aspects, the outer surface 255 can be untreated. In various aspects, the outer surface 255 can be untextured.

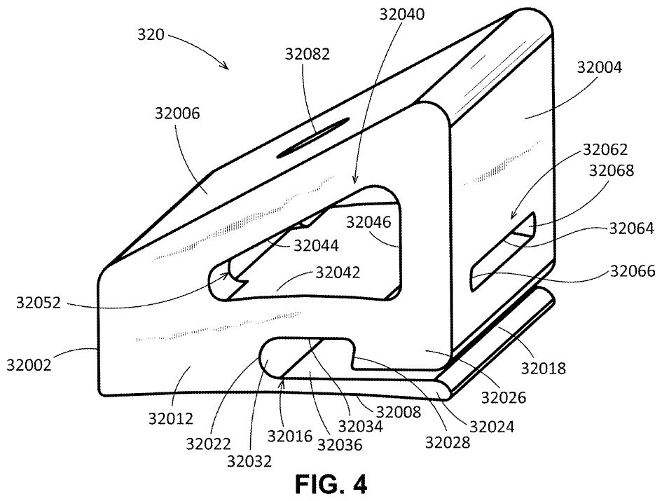

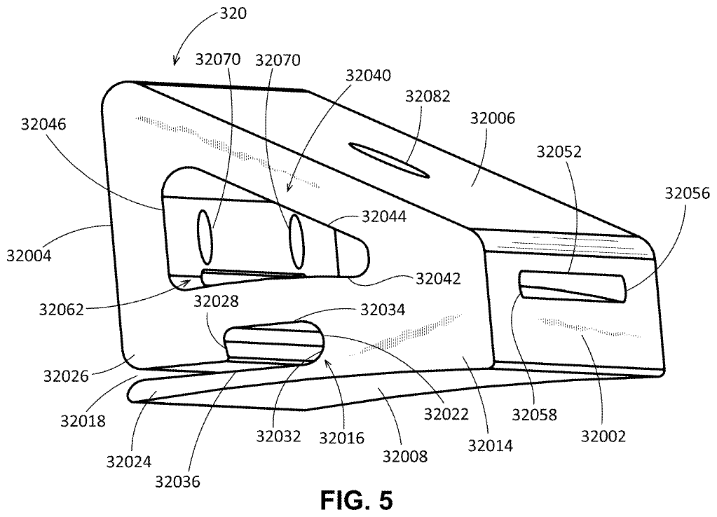

The wedge housing 320 can be seen with further reference to FIGS. 4-5. The wedge housing 320 can define a front wall 32002, a back wall 32004, a top 32006, a bottom 32008, a first side wall 32012, and a second side wall 32014 (shown in FIG. 5). The front wall 32002 can be shorter in dimension than the back wall 32004 such that the top 32006 can be angled down from the back wall 32004 to the front wall 32002.

A housing attachment void 32016 can be defined in the wedge housing 320 and can be sized to accept the second end 120 of the housing 100. The housing attachment void 32016 can define a housing opening 32018 and an end stop opening 32022. The housing opening 32018 can be sized to accept the housing 100, and the end stop opening 32022 can be sized to accept the end stop 185. Both the housing opening 32018 and the end stop opening 32022 can be partially defined by a shelf 32024 that can partially define the bottom 32008. The housing opening 32018 can be defined on its other end by a protrusion 32026 partially defining the back wall 32004. The protrusion 32026 can also define a stop wall 32028 that partially defines the end stop opening 32022. The end stop opening 32022 can also be defined an end wall 32032, a top wall 32034, and a bottom wall 32036 that is a portion of the shelf 32024. Various curvatures and fillets can be utilized to transition between the various walls and to help define the openings, pathways, and voids described in the current disclosure. One of skill in the art would understand that varying arrangements can be utilized within the scope of the current disclosure and that no particular arrangement should be considered limiting.

A wedge void 32040 can be defined in the wedge housing 320 and can extend from the first side wall 32012 to the second side wall 32014. The wedge void 32040 in the current aspect can be defined by a bottom 32042, a top 32044, and a back 32046. The wedge void 32040 can be defined by a void of prismatic triangle shape. The wedge void 32040 can be sized to accommodate the wedge 310 to be fit within the wedge void 32040.

A front wall tongue pathway 32052 can be defined in the front wall 32002 and can be in communication with the wedge void 32040. A portion of the bottom 32042 can define a bottom extent of the front wall tongue pathway 32052. The front wall tongue pathway 32052 can also be defined by a top 32054 (shown in FIG. 5) and sides 32056,32058 (shown in FIG. 5). Similarly, a back wall tongue pathway 32062 can be defined in the back wall 32004 and can be in communication with the wedge void 32040 such as to allow the tongue 250 to pass from the wedge void 32040 into the back wall tongue pathway 32062. A portion of the bottom 32042 can define a bottom extent of the back wall tongue pathway 32062. The back wall tongue pathway 32052 can also be defined by a top 32064 and sides 32066,32068.

A pair of spring seating voids 32070 can be seen with specific reference to FIG. 5 defined in the back 32046. In the current aspect, each spring seating void 32070 can be defined of circular cross-section and be defined by a cylindrical cut-out from the back 32046. In various aspects, each spring seating void 32070 can be sized and shaped to accommodate springs 330. One of skill in the art would understand that springs can be of various shapes, sizes, and applications, and the spring seating voids 32070 should not be understood as limiting the disclosure to accommodating only specific types of springs. Various spring styles can be utilized to accommodate the purpose and function of springs 330, and one of skill in the art would understand that the spring seating voids 32070 can be modified to accommodate the various spring styles that can be implemented. In various aspects, spring seating voids 32070 can be omitted from the wedge housing 320.

An access void 32082 can be defined in the top 32006. In various aspects, the access void 32082 can be of various shapes and sizes. In the current aspect, the access void 32082 can be defined as circular in cross-section and being defined of a cylinder.

In various aspects, the wedge housing 320 can be of various materials, including various metals, plastics, polymers, and composites, including—but not limited to—ductile iron, carbon steel, stainless steel, titanium, polyethylene, polycarbonate (PC), acrylonitrile butadiene styrene (ABS), PC/ABS, fiberglass, and various combinations thereof. One of skill in the art would understand that various materials not listed herein can be utilized as well.

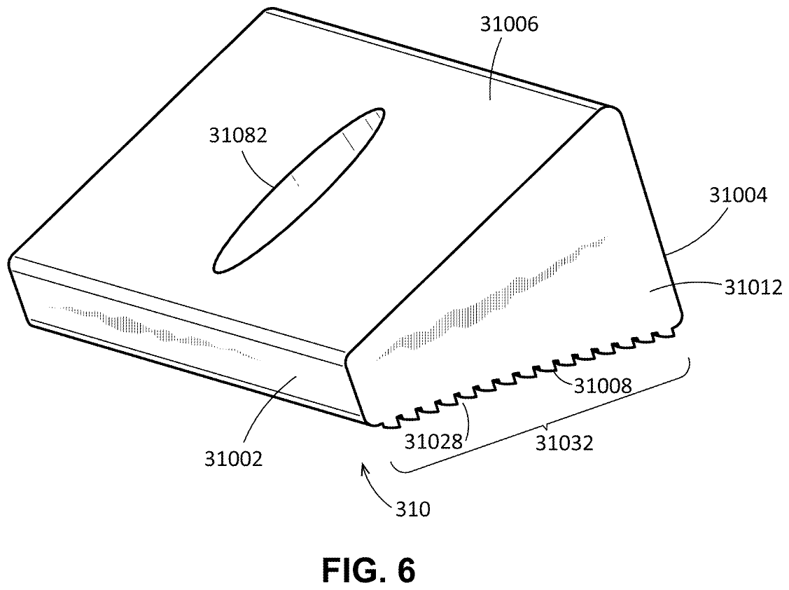

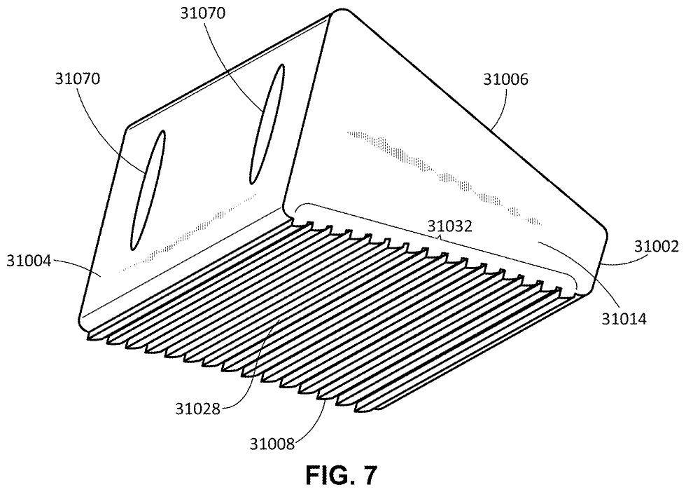

The wedge 310 can be see with reference to FIGS. 6-7. The wedge 310 can comprise a front wall 31002, a back wall 31004, a top 31006, a bottom 31008, and two side walls 31012,31014 (31014 shown in FIG. 7). The top 31006 can define an access notch 31082. In the current aspect, the access notch 31082 can be about circular in cross-section and can be defined by a cylindrical shape. The back wall 31004 can define at least one spring seating void 31070 to accommodate the spring 330. Each spring seating void 31070 (shown in FIG. 7) can be about circular in cross-section and can be defined by a cylindrical shape. One of skill in the art would understand that springs can be of various shapes, sizes, and applications, and the spring seating voids 31070 should not be understood as limiting the disclosure to accommodating only specific types of springs. Various spring styles can be utilized to accommodate the purpose and function of springs 330, and one of skill in the art would understand that the spring seating voids 31070 can be modified to accommodate the various spring styles that can be implemented. In various aspects, spring seating voids 31070 can be omitted from the wedge 310.

The wedge 310 can define a friction-inducing surface 31028 on the bottom 31008. The friction-inducing surface 31028 can be a variety of physical applications in various aspects of the current disclosure, including etching, diamond patterns, roughened surfaces, and various other methods known to those of skill in the art. In the current aspect, the friction-inducing surface 31028 can be a plurality of teeth 31032. In the current aspect, teeth 31032 defined in the bottom 31008 can be formed as extruded sections extending from one side wall 31012 to the other side wall 31014. In various aspects, the teeth 31032 can be intermittent; in various aspects, the teeth 31032 can contain gaps; in various aspects, the teeth 31032 can be angled such that individual teeth do not extend from one side wall 31012 to the other side wall 31014; in various aspects, the teeth 31032 can be spikes; in various aspects, the teeth 31032 can be tacks or nails; in various aspects, the teeth 31032 can be sharpened. One of skill in the art would understand that the friction-inducing surface 31028 can define a variety of shapes, methods, or applications known to those of skill in the art to achieve the desired frictional arrangement.

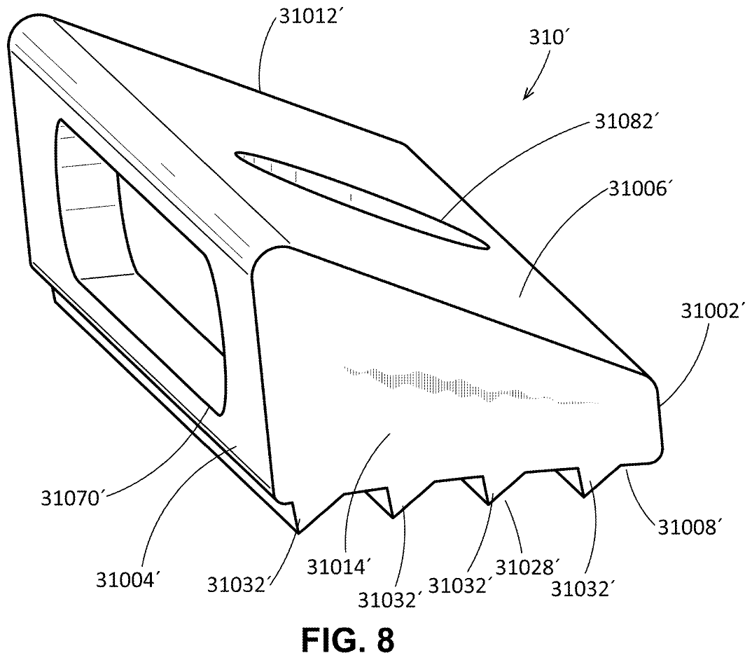

Another aspect of a wedge 310′ can be seen with reference to FIG. 8. The wedge 310′ can comprise a front wall 31002′, a back wall 31004′, a top 31006′, a bottom 31008′, and two side walls 31012′,31014′. The top 31006′ can define an access notch 31082′. The back wall 31004′ can define at least one spring seating void 31070′ to accommodate the spring 330. The spring seating void 31070′ can vary from the spring seating void 31070 in shape. In the current aspect, the spring seating void 31070′ can be an oblong shape sized to accommodate multiple springs 330. The wedge 310′ can define a friction-inducing surface 31028′ on the bottom 31008′. In the current aspect, the friction-inducing surface 31028′ can be a plurality of teeth 31032′. In the current aspect, four teeth 31032′ can extend from the bottom 31008′ to form the friction induing surface 31028′. The four teeth 31032′ can be larger than the teeth 31028 of the wedge 310. In the current aspect, teeth 31032′ defined in the bottom 31008′ can be formed as extruded sections extending from one side wall 31012′ to the other side wall 31014′. In various aspects, the teeth 31032′ can be intermittent; in various aspects, the teeth 31032′ can contain gaps; in various aspects, the teeth 31032′ can be angled such that individual teeth do not extend from one side wall 31012′ to the other side wall 31014′; in various aspects, the teeth 31032′ can be spikes; in various aspects, the teeth 31032′ can be tacks or nails; in various aspects, the teeth 31032′ can be sharpened. One of skill in the art would understand that the friction-inducing surface 31028′ can define a variety of shapes, methods, or applications known to those of skill in the art to achieve the desired frictional arrangement.

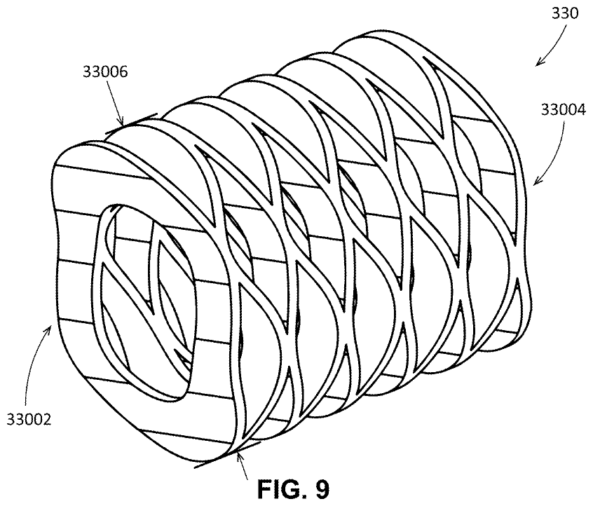

The spring 330 can be seen with reference to FIG. 9. The spring 330 can comprise a first lateral end 33002 and a second lateral end 33004. In the current aspect, the spring 330 can be a stacked wave disc spring. In various aspects, the spring 330 can be of various shapes and applications as would be understood to one of skill in the art. For example, in various aspects, the spring 330 can be a helical coil spring; a leaf spring; and a torsional spring among various other types of springs. The spring 330 can be made of metals, composites, polymers, rubbers, or various combinations thereof. In the current aspect, the spring 330 can define a diameter 33006. The spring 330 can be sized to be accommodated within the spring seating voids 31070,32070. In various aspects, the spring 330 can be omitted from the clamp 5000.

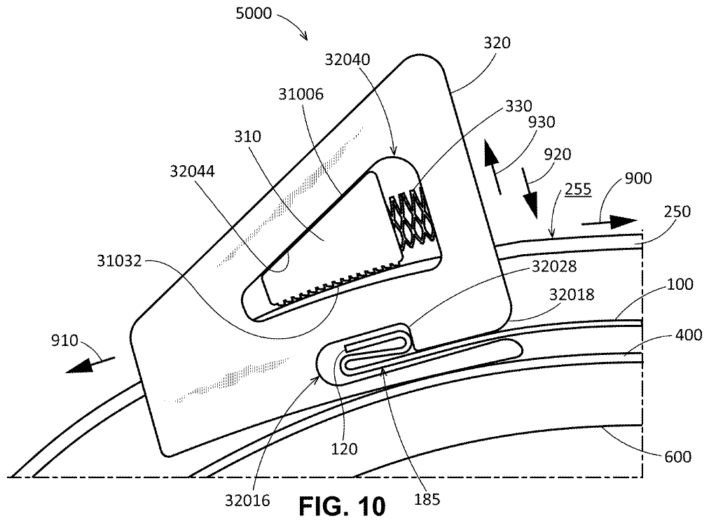

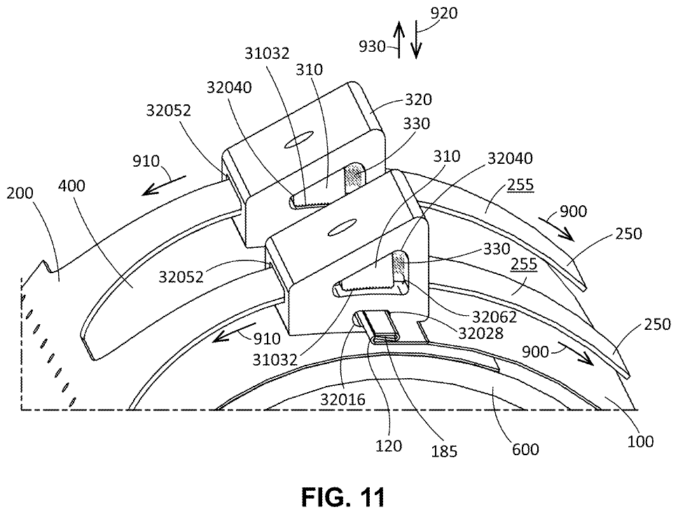

Engagement of the clamp 5000 can be seen with reference to FIGS. 10-11. Each tongue 250 can be located within the front wall tongue pathway 32052 and the back wall tongue pathway 32062 of the corresponding wedge housing 320. To engage the clamp 5000, each tongue 250 can be pulled in a tightening direction 900 such that each tongue 250 can slip with respect to each wedge 310. Such action can be accomplished by use of a tool that can be designed to grip the ends of each tongue 250 and move each tongue 250 with respect to each wedge 310. Although each tongue 250 can move with respect to each wedge 310 in the tightening direction 900, the stop end 185 can be located at the second end 120 of the housing 100 and can be prevented from moving in the tightening direction 900 by the housing attachment void 32016. As such, the housing 100 can become tightened around the clamp shield 400 and the gasket 600 thereby providing compressive force on the gasket 600. Each wedge 310 can be biased in an opposite direction 910 (also termed as a “non-tightening direction”) by at least one of the springs 330 such each tongue 250 can slip in the tightening direction 900 and each wedge 310 can slip in the opposite direction 910.

As each tongue 250 slips in the tightening direction 900, other parts of the housing 100 as connected to the tongue attachment 200 can be pulled in the tightening direction 900 as well. Each stop end 185 can be pulled into contact with its respective stop wall 32028 by this action, thereby pulling the corresponding wedge housing 320 in the tightening direction 900 as well. Compressive forces on the gasket 600 can increase as a result of this action, thereby promoting sealing action of the gasket 600 against any piping element within the clamp 5000. As each wedge housing 320 gets pulled in the tightening direction 900, the corresponding wedge 310 can be biased or pushed in the opposite direction 910 by one or more of spring 330. The top 31006 of such wedge 310 can come into contact with top 32044 of the wedge void 32040 thereby forcing the wedge 310 in a radially inward direction 920. Such force can allow the teeth 31032 to be forced into the outer surface 255 of the tongue 250, causing the clamping assembly 300 to engage the tongue 250. The teeth 31032 can be biased against radial pullout in the opposite direction 910 such that the tongue 250 can be prevented from moving in the opposite direction 910 while simultaneously being allowed to move in the tightening direction 900. A radially outward direction 930 is also shown for reference.

As noted previously a tightening tool (not shown) can be used to achieve these results. It is noted that the clamp 5000 can omit traditional fasteners such as bolts, washers, nuts, and lugs. In doing so, the clamp 5000 can address a wide range of diameters of piping elements while also being of relatively low cost due to the omission of costly components. A single tightening tool can be used for multiple applications and multiple sizes of clamps 5000 such that the tool can be an element of the installation equipment. With removal of the costly fastening elements, the clamp 5000 can reduce costs by 15% over wide range clamps containing traditional fastening elements.

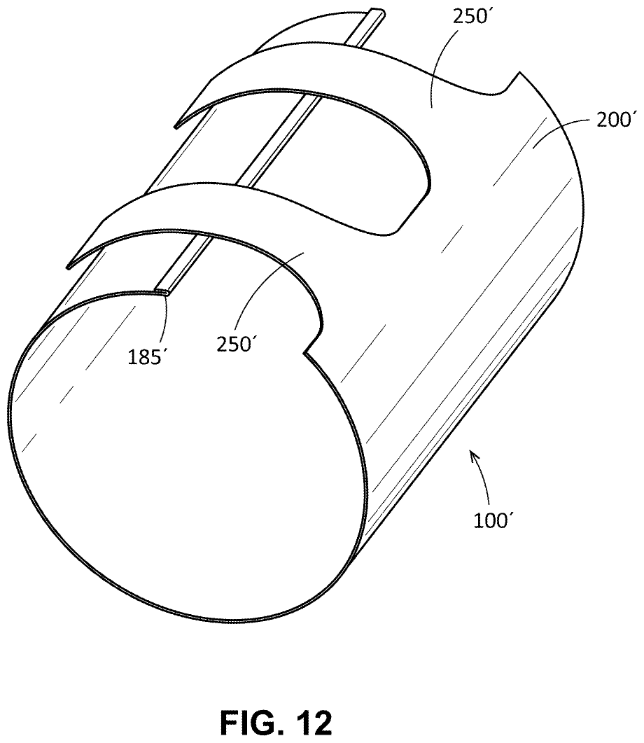

A modified housing 100′ can be seen with reference to FIG. 12. The housing 100′ can comprise an integrated tongue attachment portion 200′ that can be formed as single piece with the housing 100′, such as by stamping the housing 100′ out of a single piece of sheet metal. The housing 100′ can thereby be formed without rivets or joints as can be used to connect the housing 100 to the tongue attachment portion 200.

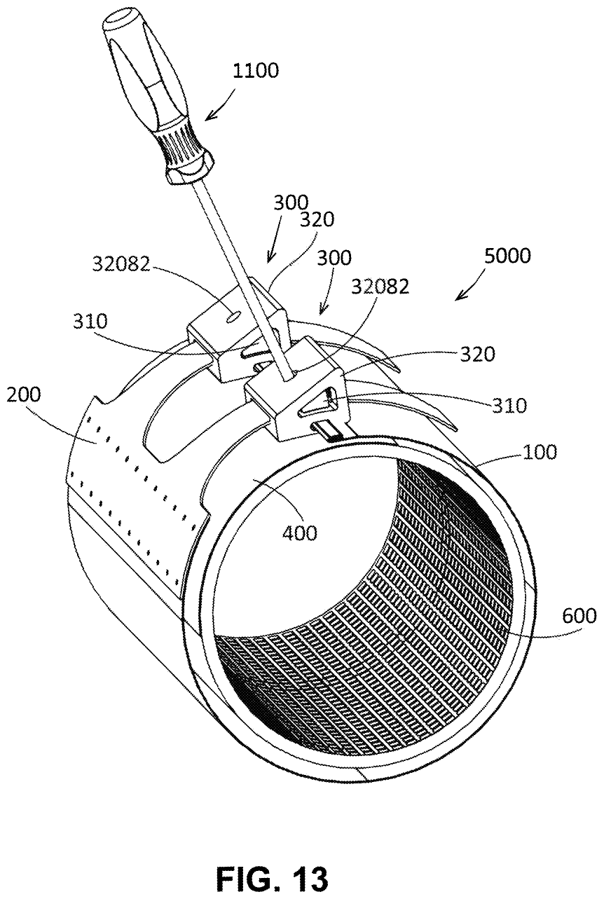

A release tool 1100 can be seen in use with the clamp 5000 in FIG. 13. The release tool 1100 can be arranged within the access void 32082 of the wedge housing 320. To achieve release, the release tool 1100 can be arranged within the access notch 31082 (not shown in the current view) and used to separate the wedge housing 320 from the wedge 310. In various aspects, the release tool 1100 can be used to pry the wedge housing 320 from the wedge 310.

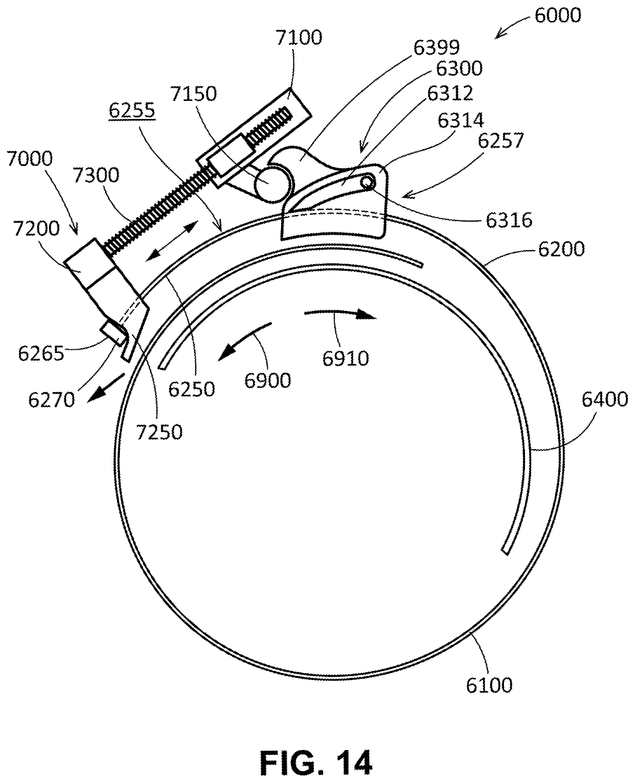

Another aspect of a clamp 6000 can be seen with reference to FIG. 14. A housing 6100 can be seen in the side view. The housing 6100 can be attached to a clamping assembly 6300. A clamp shield 6400 can be seen in its approximate arrangement in the clamp 6000. The housing 6100 can be connected to a tongue attachment 6200. The tongue attachment 6200 can define at least one tongue 6250 which can comprise an outer surface 6255. In the current aspect, each outer surface 6255 can comprise a plurality of teeth 6257. The teeth 6257 can be arranged to interact with a cam arm 6312. The cam arm 6312 can be biased into engagement with the teeth 6257 by a spring (not shown). The cam arm 6312 can be rotatably connected to a cam housing 6314 by a pin 6316. In such an arrangement, the cam arm 6312 can be arranged to engage with the teeth 6257 to allow motion of each tongue 6250 in a tightening direction 6900 but to restrict motion of each tongue 6250 in the opposite direction 6910.

In the current aspect, each tongue 6250 can comprise a tongue end 6265. Each tongue end 6265 can comprise an anchor 6270. The anchor 6270 can be an expanded feature of the tongue 6265 that can provide a location to connect a clamping tool 7000. The cam housing 6314 can also define an anchor location 6399. In the current aspect, the anchor location 6399 can be a protrusion or arm extending from the cam housing 6314. In various aspects, the anchor location 6399 can be a feature of the cam housing 6314 such as a dimple or concavity that can allow interaction with the clamping tool 7000.

The clamping tool 7000 of the current aspect can comprise electric or hydraulic actuation, among other potential methods of actuation. The clamping tool 7000 can comprise a main body 7100 and an anchor body 7200. The main body 7100 can comprise an anchor 7150 that can be designed to interact with the anchor location 6399. Similarly, the anchor body 7200 can comprise an anchor 7250 that can be designed to interact with the anchor 6270. The main body 7100 can be connected to the anchor body 7200 by an actuation shaft 7300. In various aspects, the actuation shaft 7300 can be made of metal or various other sufficiently rigid compositions to provide force between the main body 7100 and the anchor body 7200. In one aspect of the clamping tool 7000, the actuation shaft 7300 can be of magnetic material; the main body 7100 can comprise an electromagnetic actuator to force the actuation shaft 7300 away from the main body 7100. In such an arrangement, the anchor body 7200 can force the anchor 6265 in the tightening direction 6900, and the anchor 7150 can force the clamping assembly 6300 in the opposite direction 6910 such that a tightening force is applied to the clamp 6000.

In various aspects, the actuation shaft 7300 can be hydraulically actuated. In such aspects, the main body 7100 can comprise a hydraulic cylinder and additional apparatus known to one of skill in the art to be necessary for hydraulic force. In various aspects, the actuation shaft 7300 can be threaded. In such aspects, the main body 7100 can comprise an electric motor that can be turned to provide actuation force to the shaft 7300 to separate the anchor 6265 from the clamping assembly 6300 to provide clamping force in the manner described above. In various aspects, the electric motor can be a direct current (DC) motor; in various aspects, the electric motor can be an alternating current (AC) motor. In various aspects, the electric motor can be omitted in favor of a hand crank mechanism, operating similarly to an automotive jack.

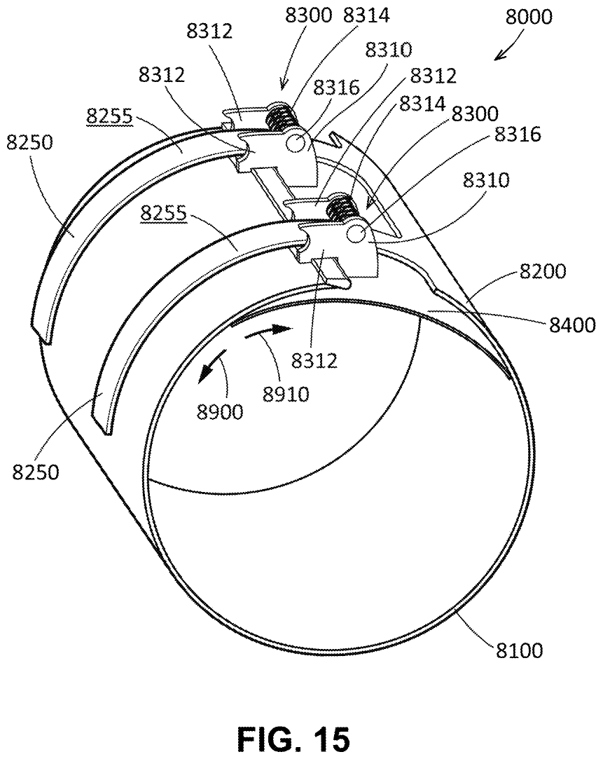

Another aspect of a clamp 8000 can be seen with reference to FIG. 15. A housing 8100 can comprise a tongue attachment 8200. A clamp shield 8400 can be seen arranged in an approximate location. The tongue attachment 8200 can comprise at least one tongue 8250, each tongue 8250 defining a surface 8255. A clamping assembly 8300 can be utilized to grip each tongue 8250. In the current aspect, the clamping assembly 8300 can be of a ratcheting style. A ratchet housing 8310 can be connected to at least one ratchet arm 8312. In various aspects, multiple ratch arms 8312 can be connected to each other. A ratchet pinion 8314 can be arranged on a pin 8316 and configured to grip the surface 8255 while continually forcing each the tongue 8250 in a tightening direction 8900. An opposite direction 8910 can be seen for reference. In operation, as each ratchet arm 8312 is actuated, the ratchet pinion 8314 can grip the surface 8255 during rotation and can force the tongue 8250 in the tightening direction 8900 thereby providing clamping force on a piping element located within the clamp 8000. Much like a strap ratchet as would be known to one of skill in the art, successive actuations of each ratchet arm 8312 can provide additional clamping force.

One should note that conditional language, such as, among others, “can,” “could,” “might,” or “may,” unless specifically stated otherwise, or otherwise understood within the context as used, is generally intended to convey that certain aspects include, while other aspect do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A clamp for encapsulating a piping element, the clamp comprising:
a housing, the housing defining a first end and a second end;
at least one tongue connected to the housing and extending proximate the first end;
a gasket arranged within and in contact with the housing, the gasket arranged to encapsulate the piping element; and
at least one clamping assembly coupled to the second end,
wherein each clamping assembly engages at least one tongue.

2. The clamp of claim 1, wherein at least one clamping assembly comprises a wedge housing and a wedge arranged within the wedge housing.

3. The clamp of claim 2, wherein
the wedge housing comprises a front wall, a back wall, a top, and a bottom, the wedge housing thereby defining two sides;
the front wall defining a front wall tongue pathway;
the back wall defining a back wall tongue pathway; and,
the wedge housing defining a wedge void, the wedge void in communication with the front wall tongue pathway and the back wall tongue pathway,
wherein one tongue is arranged within the front wall tongue pathway, the wedge void, and the back wall tongue pathway in contact with the wedge.

4. The clamp of claim 3, wherein the wedge can define a front wall, a back wall, a top, a bottom, and two side walls, wherein the bottom of the wedge comprises a friction-inducing surface.

5. The clamp of claim 4, wherein the friction-inducing surface is a plurality of teeth.

6. The clamp of claim 1, wherein each tongue is integrated with a tongue attachment, where the tongue attachment is connected to the housing.

7. The clamp of claim 1, wherein each tongue is integrated with the housing.

8. The clamp of claim 1, wherein at least one clamping assembly comprises
a cam housing; and
a cam arm rotatably connected to the cam housing.

9. The clamp of claim 8, wherein each tongue defines teeth, wherein the cam arm engages the teeth.

10. The clamp of claim 9, wherein each tongue defines an anchor and wherein the cam housing defines an anchor.

11. The clamp of claim 10, wherein a tool engages the tongue anchor and the cam housing anchor, wherein the tool moves the tongue anchor in a tightening direction.

12. The clamp of claim 1, wherein at least one clamping assembly comprises a ratchet housing and a ratchet arm rotatably connected to the ratchet housing.

13. A clamp comprising:
a housing, the housing defining a first end and a second end;
a first tongue connected to the housing and extending proximate the first end;
a second tongue connected to the housing and extending proximate the first end;
a first clamping assembly and a second clamping assembly, each clamping assembly comprising
a wedge housing defining a top, a bottom, a front wall, a back wall, a first side wall, and a second side wall, the front wall being of a smaller dimension than the back wall such that the top is angled with respect to the bottom, wherein the front wall defines a front wall tongue pathway, wherein the back wall defines a back wall tongue pathway, and wherein the wedge housing defines a wedge void in communication with the front wall tongue pathway and with the back wall tongue pathway;
a wedge arranged within the wedge void, the wedge defining a top, a bottom, a front, a back, a first side, and a second side, wherein the top of the wedge is angled with respect to the bottom, wherein the top of the wedge is in contact with a top of the wedge void;
the first clamping assembly coupled to the second end, wherein the first tongue is arranged within the front wall tongue pathway and the back wall tongue pathway of the first clamping assembly, wherein the wedge of the first clamping assembly is in contact with a surface of the first tongue; and
the second clamping assembly coupled to the second end, wherein the second tongue is arranged within the front wall tongue pathway and the back wall tongue pathway of the second clamping assembly, wherein the wedge of the first clamping assembly is in contact with a surface of the second tongue.

14. The clamp of claim 13, wherein the bottom of each wedge defines a plurality of teeth.

15. The clamp of claim 14, wherein the surface of each tongue is a friction-inducing surface.

16. The clamp of claim 15, wherein the friction-inducing surface defines a plurality of teeth.

17. The clamp of claim 13, wherein the first wedge is connected to the first wedge housing by at least one spring and wherein the second wedge is connected to the second wedge housing by at least one spring.

18. The clamp of claim 17, wherein each spring is a stacked wave disc spring.

19. The clamp of claim 13, wherein the second end defines an end stop, wherein the end stop is arranged within an end stop opening defined in each wedge housing.

20. A method of installing a clamp onto a piping element, the method comprising:
obtaining a clamp, the clamp comprising
a housing, the housing defining a first end and a second end;
at least one tongue connected to the housing and extending proximate the first end;
a gasket arranged within and in contact with the housing, the gasket arranged to encapsulate the piping element; and
at least one clamping assembly coupled to the second end;
arranging the gasket around the piping element;
arranging the clamp around the gasket and piping element;
inserting at least one tongue into at least one clamping assembly;
arranging a clamping tool in contact with the clamping assembly and with a portion of one tongue; and
actuating the clamping tool to achieve tightening of the clamp by moving at least one tongue in a tightening direction with respect to at least one clamping assembly.
